(19) United States
(12) Patent Application Publication
(10) Pub. No.: US 2008/0247517 A1
(43) Pub. Date: Oct. 9, 2008

(54) Technique for providing a telecommunications user with a service based on the user's location

(76) Inventor: Christopher A. Huey, Banks, OR (US)

Correspondence Address: SOFER & HAROUN LLP., 317 MADISON AVENUE, SUITE 910, NEW YORK, NY, 10017, US

(21) Appl. No.: 12/157,488

(22) Filed: Jun. 11, 2008

Related U.S. Application Data
(63) Continuation of application No. 11/025,799, filed on Dec. 29, 2004.

(51) Int. Cl. H04M 11/04; H04M 3/42

(52) U.S. Cl. 379/45; 379/201.07

(57) ABSTRACT

A broadband telecommunications carrier routes a location-based service call, e.g., an emergency service call, through a facility shared by an information/call center. This facility receives the call, along with information indicative of the location of the call originating device and, thus, the caller's location. Based on such location information, it searches a database for contact information concerning the location-based service provider, e.g., an emergency dispatch service provider, in proximity to the call-originating device location. The call is then transferred to the service provider based on the contact information identified in the database.

### FIELD OF THE INVENTION

The invention relates to a communications technique, and more particularly to a technique for providing a telecommunications user with a location based service.

### BACKGROUND OF THE INVENTION

Provision of telecommunications services based on a user's location is common which include, e.g., information assistance services providing travel directions from the user's location, emergency services dispatching medical or other help to the user's location, etc. A user typically dials “911” on a telephone to call for an emergency dispatch service. In prior art, when the emergency service call reaches the first telephone carrier switch, e.g., in an end office, such a switch is programmed to route one such 911 call to a local emergency dispatch service close to the switch, which is supposed to be close to the caller's location. A local emergency dispatch service is important to the caller because it may rely on a service dispatcher's familiarity with the caller's area, e.g., local street addresses, facilities, etc., to dispatch help for the caller in a timely and expeditious manner.

Recently, some telecommunications companies have taken advantage of underutilized bandwidth afforded by a broadband communications network, e.g., a cable network, to provide telecommunications services pursuant to the well known voice over Internet protocol (VoIP). In one such broadband telephone service, a telephone call from subscriber premises is routed at least partially through a cable network. For example, the call may be handed off to a public switched telephone network (PSTN) after it traverses a long distance via a cable connection originating from the subscriber premises.

### SUMMARY OF THE INVENTION

The invention is premised upon the recognition that when a location-based service call, e.g., an emergency service call, is handed off to a PSTN from a cable network, the switch in the PSTN receiving the call should not automatically route the call to an emergency dispatch service provider close to the switch as in prior art. This stems from the fact that even though the emergency dispatch service provider may be close to the switch, because of the long distance cable connection, the switch most likely is not close to the caller's location any more. As a result, the emergency dispatch service provider identified in prior art because of its proximity to the switch would no longer be close to the caller's location, which is not desirable.

The invention is also premised upon the recognition of a wide distribution of information/call centers to which a telecommunications carrier typically routes information assistance calls, e.g., “411” calls, whereby a caller may obtain directory assistance, directions, etc. The invention overcomes the prior art limitations by routing a location-based call from a cable network to an information/call center facility, e.g., a servicing platform, to take advantage of, among others, database lookup and call transfer capabilities there for transferring the call to a location-based service provider close to the caller's location. In accordance with an embodiment of the invention, the servicing platform receives the call from the broadband communications network, and location information indicative of a location of a communications device from which the call originates, e.g., a zip code of the area in which the communications device is located. The location information is determined based on data identifying the communications device within the broadband communications network. Contact information concerning the service provider is obtained based on the location information. A communications connection with the service provider is established using the contact information, through which the call is transferred to the service provider.

### BRIEF DESCRIPTION OF THE DRAWING

Further objects, features and advantages of the invention will become apparent from the following detailed description taken in conjunction with the accompanying drawing showing an illustrative embodiment of the invention, in which:

FIG. 1 illustrates a communications system including a broadband communications arrangement in accordance with the invention;

FIG. 2 is a block diagram of an information/call center in accordance with the invention;

FIG. 3 illustrates a call acceptance request in establishing a call session;

FIG. 4 illustrates a database containing records of subscribers of a broadband telecommunications service;

FIG. 5 is a flowchart depicting a routine for transferring a location-based service call to a service provider in proximity to the caller's location; and

FIG. 6 is a database containing contact information concerning location-based service providers in association with different location indications, respectively.

### DETAILED DESCRIPTION

The invention is directed to routing a location-based service call, e.g., an emergency service call, to an information/call center facility to effectively transfer the call to a location-based service provider, e.g., an emergency dispatch service provider. In particular, an emergency dispatch service provider close to the caller's location is desirable in that because of his/her familiarity with local street addresses, facilities, etc., a dispatcher there most likely can efficiently dispatch emergency services, e.g, medical, fire, law enforcement and other services, to the caller's location.

Recently, some telecommunications carriers have taken advantage of underutilized bandwidth afforded by a broadband communications network, e.g., a cable network, to provide telecommunications services pursuant to the VoIP. In one such broadband telecommunications service, a telephone call which may be, e.g., a location-based service call, is routed at least partially through a cable connection originating from the caller's location before it is handed off to a PSTN to complete the call. The invention is premised upon the recognition that when the first switch in the PSTN receiving a location-based service call from the cable connection, the call should not be routed to a location-based service provider close to the first switch as in prior art. This is because such a switch when receiving the call from the cable connection, which usually spans a long distance, would most likely be distant from the caller's location, and so would the service provider close to the switch. That is, a broadband telecommunications carrier can no longer rely on the location of the switch in the PSTN initially receiving a location-based service call to identify a location-based service provider close to the caller's location.

In accordance with the invention, in providing a broadband telecommunications service, a location-based service call, e.g., an emergency service call, is routed to a facility normally employed for an information/call center, thereby taking advantage of, among others, database lookup and call transfer capabilities there for transferring the call to a location-based service provider close to the caller's location. The invention also realizes cost-effectiveness by sharing the same facility as the information/call center for providing an information assistance service. The broadband telecommunications carrier monitors for any location-based service call, e.g., with specific dialed number identification service (DNIS) information accompanying the call. When one such call is detected, the carrier provides to an information/call center facility, along with the call, information indicative of the caller's location, e.g., the zip code, global positioning system (GPS), longitude and latitude information, etc. Based on such information, the information/call center facility looks up in a database the contact information concerning the location-based service provider close to the caller's location. It then uses the contact information to transfer the call to such a location-based service provider.

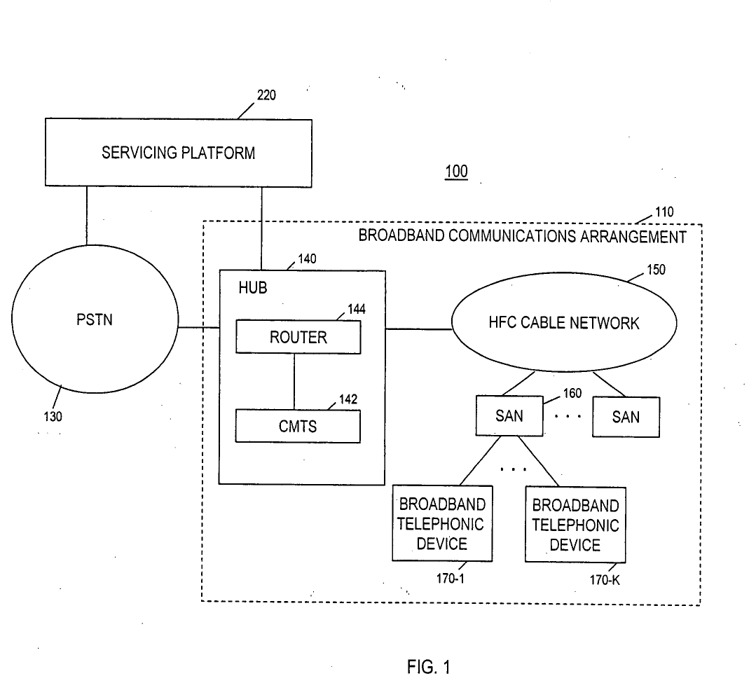

FIG. 1 illustrates communications system 100 embodying the principles of the invention for providing broadband telecommunications services including, e.g., a broadband telephone service. Broadband telephone service users may utilize broadband telephonic devices 170-l through 170-K (e.g., digital phones, cable phones, or other voice/data/video devices incorporating broadband telephonic circuitry) at various subscriber premises to make telephone calls, where K represents an integer. In this instance, devices 170-l through 170-K are in the same neighborhood whose telephone calls in a well known manner are concentrated at a service area node (SAN), e.g., 160. These calls thence are forwarded through hybrid fiber coax (HFC) cable network 150 to hub 140 for processing thereof in accordance with the invention. Each of devices 170-l through 170-K is assigned a telephone number, and designated an IP address for its identification in communications within broadband communications arrangement 110. Each broadband telephonic device in this instance includes a cable modem for modulating and demodulating transmissions through HFC cable network 150. A telephone call transmission from a broadband telephonic device contain, among others, the IP address identifying the device from which the call originates, a DNIS comprising the telephone number of, the intended recipient of the call, and the voice content of the call.

Hub 140 facilitates telephone communications through multiple SANs. Hub 140 in this instance includes cable modem termination system (CMTS) 142 configured for sending and receiving digital cable modem signals on HFC cable network 130. CMTS 142 receives upstream voice and data transmissions from the cable modems of telephonic devices, and packetizes the information in the transmissions into data packets pursuant, e.g., to the well known VoIP. Hub 140 also includes router 144 which may route the resulting VoIP call to a VoIP facility associated with PSTN 130 where the VoIP packets are reassembled to reconstruct the voice content and other information to complete the call, as in prior art. It should be noted that router 144 may route the VoIP call to PSTN 130 via the Internet to take advantage of its virtually free transport. However, in accordance with the invention, router 144 monitors for, e.g., location-based service calls, and routes such calls to one or more information/call center facilities, e.g., servicing platform 220, for their handling and subsequent transfer to appropriate location-based service providers, which process is transparent to the callers.

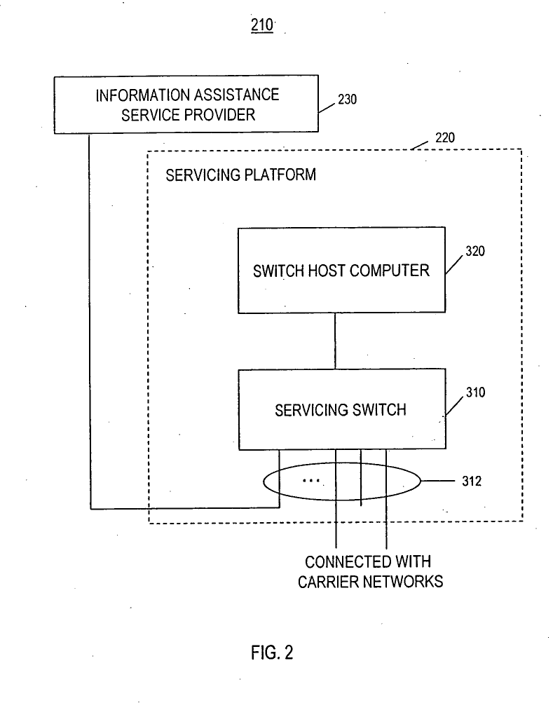

FIG. 2 illustrates information/call center 210, which may be configured to include information assistance service provider 230 together with servicing platform 220. It should be noted that even though both service provider 230 and servicing platform 220 appear in the same figure, they may or may not be located in the same geographic area. Servicing platform 220 includes servicing switch 310 having T1 spans 312 for connection to one or more voice servers and operators in provider 230 for providing traditional information assistance services including, e.g., directory assistance, travel directions, “concierge” services, stock quotation, etc. The “concierge” services include, e.g., a restaurant guide and reservation service, event information, ticketing and reservation service, hotel reservation and availability service, travel or flight reservation and ticketing service, ordering specific items such as flowers or food delivery, arranging transportation, and accessing entertainment guides.

T1 spans 312 also provide connections for one or more carrier network arrangements including, e.g., broadband communication arrangement 110 in this instance. Servicing switch 310 may receive an incoming call from a carrier network arrangement, and place an outgoing call onto a carrier network arrangement which may be the same as or different from that used for the incoming call.

Servicing switch 310 in this instance supports digital T1 connectivity, and its operation is governed by instructions stored in switch host computer 320. In this illustrative embodiment, servicing switch 310 includes, among other things, arrays of digital signal processors (DSPs). These DSPs can be programmed and reprogrammed to function as, among other things, call progress analyzers (CPAs), call progress generators (CPGs), multi-frequency (MF) tone generators/detectors, voice recognizers, dual-tone-multi-frequency (DTMF) generators/detectors, or conference units, depending on the demand placed on information/call center 210 and servicing switch 310 for each corresponding function.

For example, in prior art servicing switch 310 may be used to connect an incoming information assistance call to an available operator's telephone in provider 230 to provide the traditional information assistance services. However, in this illustrative embodiment, switch 310 may also be used to transfer a location-based service call, e.g., an emergency service call, from broadband communications arrangement 110 to an appropriate location-based service provider, e.g., an emergency dispatch service provider, close to the caller's location. To that end, router 144 in arrangement 110 may conduct handshaking with switch host computer 320, through switch 310, to establish a VoIP call session before router 144 forwards a VoIP emergency service call thereto. A well known session initiation protocol (SIP) is used in this instance for establishing and terminating a VoIP call session. For details on the SIP, one may refer, e.g., to: “SIP: Protocol Overview,” http://www.radvision.com, Radvison Ltd., 2001.

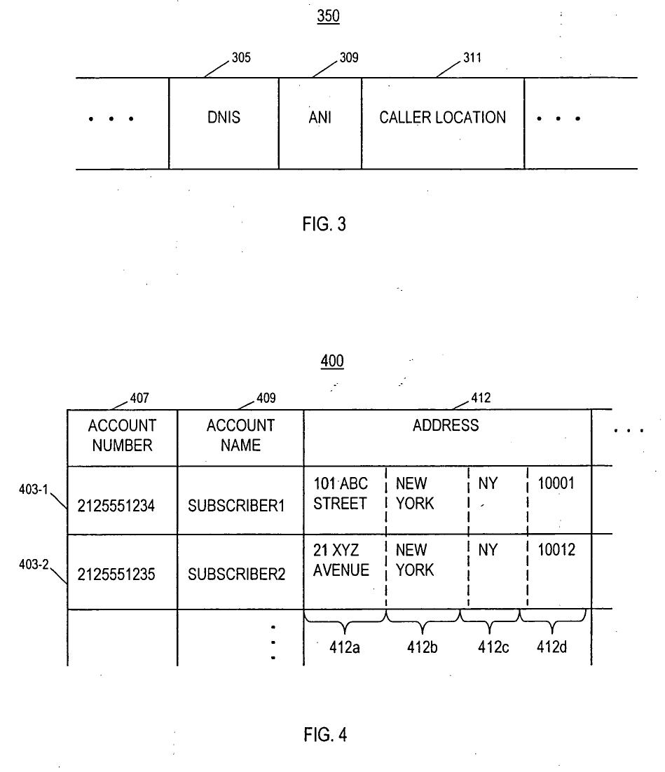

In accordance with the SIP, router 144 issues a call acceptance request, e.g., a SIP invite message, inviting computer 320 to accept the VoIP emergency service call. FIG. 3 illustrates one such request denoted 350 which includes, among others, field 305 containing the DNIS, e.g., “911” in this instance; ANI field 309 containing the telephone number of the device from which the caller makes the call; and field 311 containing information concerning the caller's location, in accordance with the invention. Router 144 obtains the DNIS information from the VoIP packets associated with the emergency service call from the caller. Router 144 derives the automatic number identification (ANI) information from the IP address of the call originating device appearing in the VoIP packets. To that end, router 144 consults an address translation table which may be stored in router 144 or elsewhere in arrangement 110, e.g., a headend (not shown). This table lists IP addresses designated to the telephonic devices, including, e.g., 170-l through 170-K, in arrangement 110 and the telephone numbers associated therewith. Thus, router 144 may look up in the address translation table the telephone number associated with the IP address of the device from which the call originates, and inserts such a telephone number in ANI field 309. In addition, based on such ANI information, router 144 may search a billing database for information concerning the location of the call originating device, and thus the caller's location.

FIG. 4 illustrates billing database 400 used by the broadband telecommunications carrier to bill its subscribers for telephone service charges. Database 400 includes L subscriber account records, e.g., 403-1, 403-2 . . . , and may be stored in router 144 or elsewhere in arrangement 110, where L represents the number of subscribers. Each account record includes, among others, Account Number field 407 which in this instance contains the telephone number assigned to the subscriber telephonic device; Account Name field 409 which contains the subscriber's name associated with the account record; and Address field 412 which contains an address at which the telephonic device is installed or located. Field 412 in this instance includes subfields 412a, 412b, 412c and 412d containing the street address, city, state and zip code portions of the address, respectively.

Based on the ANI derived in the manner described above, router 144 conducts a “reverse” lookup and searches database 400 for the corresponding address of the call originating device and, in particular, the zip code thereof in subfield 412d. In this illustrative embodiment, router 144 inserts the zip code from subfield 412d into the Caller Location field 311 in call acceptance request 350.

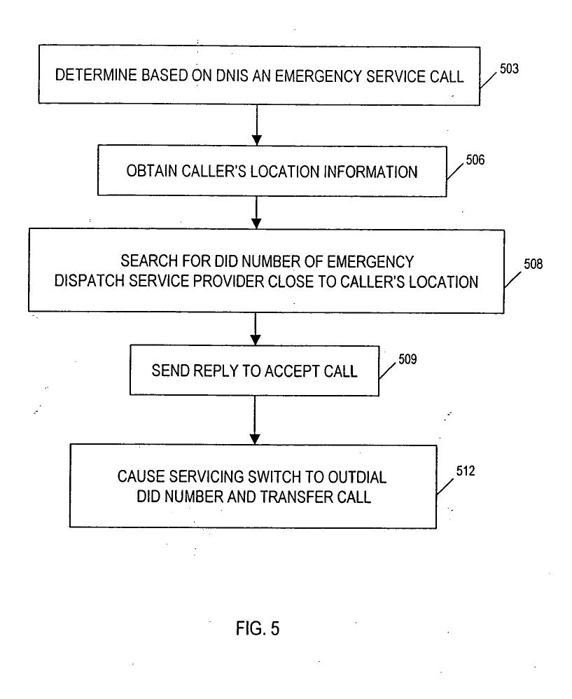

Referring to FIG. 5, upon receiving one such call acceptance request, computer 320 at step 503 determines based on the telephone number from DNIS field 305, e.g., “911” in this instance that the call to be accepted is an emergency service call. At step 506, computer 320 obtains the caller's location information, e.g., a zip code, from field 311 of the request. Based on the zip code information, computer 320 at step 508 searches an emergency service database for the direct inward dialing (DID) number of an emergency dispatch service provider close to the caller's location.

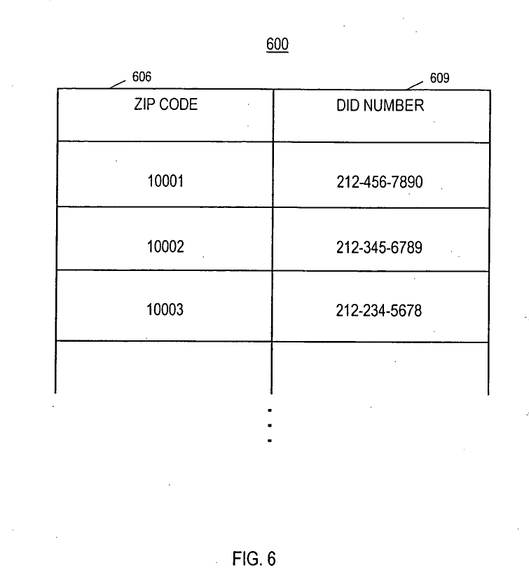

FIG. 6 illustrates such an emergency service database (denoted 600) where, for each zip code 606, the DID number 609 of an emergency dispatch service provider is listed, which is preassigned to serve the corresponding zip code area based on the proximity of the provider thereto.

At step 509, computer 320 sends to router 144 a reply, e.g., a SIP OK message, to accept the call. In response to the call acceptance reply, router 144 forwards the emergency service call to switch 310. Computer 320 at step 512 causes servicing switch 310 to outdial the DID number of the emergency dispatch service provider just identified, and transfer the call in question to the same via, e.g., PSTN 130.

The foregoing merely illustrates the principles of the invention. It will thus be appreciated that those skilled in the art will be able to devise numerous other arrangements which embody the principles of the invention and are thus within its spirit and scope.

For example, in the disclosed embodiment, the location based service provider is identified based on a zip code of the address where the call originating telephonic device, and thus the caller, is located. It will be appreciated that other information indicating the location of the device, e.g., GPS information, longitude and latitude of the device location, etc., may be used, instead. Such location information, e.g., GPS information, may be generated by the device itself which may incorporate a GPS device providing such information.

Further, in the disclosed embodiment, the emergency service call illustratively is transported, in part, pursuant to the VoIP. However, it will be appreciated that other communication protocols or formats, e.g., a time division multiplexed (TDM) format, may be used, instead.

In addition, some or all of the functionalities of hub 140 in the disclosed embodiment, e.g., those of CMTS 142 and router 144, may reside elsewhere in the broadband communications arrangement, including the headend (not shown) therein.

Finally, communications system 100 is disclosed herein in a form in which various functions are performed by discrete functional blocks. However, any one or more of these functions could equally well be embodied in an arrangement in which the functions of any one or more of those blocks or indeed, all of the functions thereof, are realized, for example, by one or more appropriately programmed processors.

What is claimed is:

1. A system for facilitating routing of a call from a broadband communications network to a service provider in proximity to an originator of the call, the system comprising:
an interface for receiving the call from the broadband communications network, and location information indicative of a location of a communications device from which the call originates, the location information being determined based on data identifying the communications device within the broadband communications network;
a database;
a processing unit configured to search the database for contact information concerning the service provider based on the location information; and
a mechanism for establishing a communications connection with the service provider using the contact information, the call being transferred to the service provider through the communications connection.

2. The system of claim 1 wherein the broadband communications network includes a cable network.

3. The system of claim 1 wherein the data includes an Internet protocol (IP) address.

4. The system of claim 1 comprising at least part of a call center.

5. The system of claim 1 wherein the service provider provides a location-based service.

6. The system of claim 5 wherein the location-based service includes an emergency dispatch service.

7. The system of claim 1 wherein the contact information includes a telephone number.

8. The system of claim 1 wherein the location information includes a zip code of an area in which the communications device is located.

9. The system of claim 1 wherein the location information includes global positioning system (GPS) information.

10. The system of claim 1 wherein the location information includes longitude and latitude information.

11. A system for routing a call from a broadband communications network, comprising:
a processor configured to determine whether the call is a location-based service call, a request being generated for transfer of the call to a service provider in proximity of an originator of the call if it is determined that the call is a location-based service call, the request including data indicative of a location of a broadband communications device from which the call originates; and
an interface for sending the request to a switching unit, which uses the data in the request to search for contact information concerning the service provider to realize the transfer of the call through a second communications network, different from the broadband communications network.

12. The system of claim 11 wherein the broadband communications network includes a cable network.

13. The system of claim 11 wherein the second communications network includes a telephone network.

14. The system of claim 11 wherein the data includes a zip code of an area in which the broadband communications device is located.

15. The system of claim 11 wherein the data includes GPS information.

16. The system of claim 11 wherein the data includes longitude and latitude information.

17. The system of claim 11 wherein the service provider provides a location-based service.

18. The system of claim 17 wherein the location-based service includes an emergency dispatch service.

19. The system of claim 11 wherein the contact information includes a telephone number.

20. The system of claim 11 wherein the switching unit is included in a call center.
